(19) United States
(12) Patent Application Publication
(10) Pub. No.: US 2024/0029976 A1
(43) Pub. Date: Jan. 25, 2024

(54) PROTECTIVE ELEMENT

(71) Applicant: SCHOTT Japan Corporation, Kota-shi (JP)

(72) Inventors: Shintaro NAKAJIMA, Koka-shi (JP); Masayuki MATSUMOTO, Koka-shi (JP); Tokihiro YOSHIKAWA, Koka-shi (JP); Shuichi HORI, Koka-shi (JP)

(21) Appl. No.: 18/372,941

(22) Filed: Sep. 26, 2023

Related U.S. Application Data
(63) Continuation of application No. 17/770,424, filed on Apr. 20, 2022.

(30) Foreign Application Priority Data
Apr. 13, 2020 (JP) 2020-071449

(51) Int. Cl. H01H 37/76; H01H 69/02

(52) U.S. Cl. CPC H01H 37/76; H01H 69/02; H01H 2037/768

(57) ABSTRACT

A protective element includes: at least two electrode portions (main electrodes) supported by an insulating support (insulating substrate); a fuse element that connects the electrode portions; and an operating flux provided on the fuse element. The operating flux has, on a surface thereof, a coating layer that covers the operating flux to prevent the operating flux from flowing.

### TECHNICAL FIELD

The present disclosure relates to a protective element used in electric devices and electronic devices.

### BACKGROUND ART

With rapid spread of small electronic devices such as mobile devices in recent years, a protective element also smaller in size and thickness is mounted on a protective circuit for a mounted power supply. For example, for a protective circuit for a secondary battery pack, a chip protective element for a surface mount device (SMD) is suitably used. The chip protective element includes a one-shot protective element that senses excessive heat generation caused by an overcurrent in a protected device and blows a fuse to cut off an electric circuit under a prescribed condition, or blows a fuse to cut off an electric circuit under a prescribed condition in response to abnormal overheating of ambient temperature.

When the protective circuit senses an abnormal condition that occurs in a device, the protective element has a resistive element generate heat with a signal current in order to ensure safety of the device. The protective element cuts off the circuit by fusing a fuse element composed of an alloy material fusible by generated heat of the resistive element or cuts off the circuit by fusing the fuse element with an overcurrent.

Japanese Patent Laying-Open No. 2013-239405 (PTL 1) discloses a protective element in which a resistive element that generates heat at the time of occurrence of an abnormal condition is provided on an insulating substrate such as a ceramic substrate.

Currently, a fusible alloy that makes up the fuse element of the protective element described above tends to be lead-free in order to follow stronger regulations on chemical substances under an amended RoHS directive or the like. A fuse element composed of a lead-free metal composite material described in Japanese Patent Laying-Open No. 2015-079608 (PTL 2) is available. The fuse element is composed of a fusible low-melting-point metal material that can melt at a working temperature of soldering in surface mount of the protective element on an external circuit substrate and a high-melting-point metal material in a solid phase that can be dissolved into the low-melting-point metal material in a liquid phase at the working temperature of soldering. In the fuse element, the low-melting-point metal material and the high-melting-point metal material are integrally formed, thereby holding the low-melting-point metal material that has been converted to the liquid phase with the use of the high-melting-point metal material in the solid phase until the soldering work is completed.

The low-melting-point metal material and the high-melting-point metal material of the fuse element are formed in a state of being secured to each other. While the low-melting-point metal material that has been converted to the liquid phase at the working temperature of soldering is held without being fused by the high-melting-point metal material in the solid phase at the working temperature of soldering, the fuse element is joined to an electrode pattern of the protective element with the low-melting-point metal material in the liquid phase. Fusing of the fuse element at the working temperature of soldering in surface mount of the protective element on the circuit substrate is prevented. The protective element performs a fusing operation by having a contained resistive element generate heat to diffuse or dissolve with heat, the high-melting-point metal material of the fuse element into the low-melting-point metal material serving as a medium.

In the protective element, it is necessary to apply an operating flux to a surface of the fuse element and hold the operating flux on the surface until the fuse element is fused, in order to guarantee normal fusing of the fuse element. Since a conventional flux for a protective element is rich in thermal fluidity, the flux applied to the surface of the fuse element flows from a surface of a fuse alloy when the protective element is exposed to thermal environment such as a reflow furnace at the time of mounting of the protective element on the circuit substrate. As a result, the operating flux may in some cases be lost from the surface of the fuse alloy.

When the flux is lost from the surface of the fuse alloy, spherical fusing of the fuse alloy is prevented, which leads to non-fusing, or poor fusing such as stringing caused by an oxide or the like remaining on the alloy surface. Therefore, as described in Japanese Patent Laying-Open No. 2010-003665 (PTL 3), for example, an insulating cover member that covers a fuse element of a protective element is provided with a stepped portion that holds a flux at a prescribed position. The stepped portion is formed by a protrusive stripe. The flux is applied while being brought into contact with the circularly formed stepped portion and a center part of a fuse alloy, and the flux is held using interfacial tension of the flux and the insulating cover member.

As described in Japanese Patent Laying-Open No. 2014-091162 (PTL 4), a protective element having adhesiveness improved by containing an inorganic filler in an operating flux is available.

### CITATION LIST

### Patent Literature

PTL 1: Japanese Patent Laying-Open No. 2013-239405
PTL 2: Japanese Patent Laying-Open No. 2015-079608
PTL 3: Japanese Patent Laying-Open No. 2010-003665
PTL 4: Japanese Patent Laying-Open No. 2014-091162

### SUMMARY OF INVENTION

### Technical Problem

A conventional flux contains an organic thixotropic agent, and when a temperature of the flux is increased to a reflow temperature (maximum temperature of 250 to 260° C.), the flux loses thixotrophy and cannot hold the shape for flowing. Therefore, as described in PTL 3, restriction of a flow range of the operating flux that flows under thermal environment is necessary. In order to restrict the flow range, it has been necessary to use a particular package structure such as a structure in which the stepped portion is provided on a portion of the insulating cover member that faces the center part of the fuse element. In addition, as described in PTL 4, it has been necessary to carry, with filler particles, the operating flux that has been liquefied under thermal environment and improve the holding force by adding the filler particles to the operating flux.

However, when the insulating cover member is provided with the stepped portion as described in PTL 3, the stepped portion of the insulating cover member makes an internal space narrower particularly in a small and thin package. As a result, when the fuse alloy is fused, the molten fuse alloy is pushed out from an electrode portion to form a bridge between electrodes, or wet flowing of the molten fuse alloy to the electrode portion is inhibited, which leads to poor fusing.

More specifically, the molten fuse alloy gathers in a dome shape on the heated electrode due to surface tension and is fused, while wetting the heated electrode portion. A height of the molten alloy formed in a dome shape is restricted by the stepped portion (protrusive stripe) provided on the cover member. Therefore, the excess molten alloy overflows around the electrode and forms a bridge between the electrodes, which leads to non-fusing.

In addition, since the insulating cover member is provided with the stepped portion, the insulating cover member increases in thickness. This structure is disadvantageous for reduction in profile of a product. Furthermore, forming a part of the package into a particular shape makes the package structure complicated, which leads to an increase in component cost.

In the operating flux having the filler particles added thereto as described in PTL 4, the inorganic filler is contained in the operating flux to thereby form a paste having low fluidity. By holding the operating flux between the filler particles, the operating flux applied to the surface of the fuse alloy is less likely to flow from the surface of the fuse alloy even when the protective element is exposed to thermal environment. However, surface tension of the operating flux decreases with an increase in temperature. Therefore, under a severe heating condition, the holding capacity of the filler reaches a limit when a prescribed temperature is exceeded, and thus, flowing cannot be completely suppressed.

An object of the present disclosure is to provide a protective element for electric devices and electronic devices that prevents an operating flux applied to a surface of a fuse element from flowing from the surface of the fuse element even when the protective element is exposed to severe thermal environment.

### Solution to Problem

A protective element according to an aspect of the present disclosure includes: at least two electrode portions supported by an insulating support; a fuse element that connects the electrode portions; and an operating flux provided on the fuse element. The operating flux has, on a surface thereof, a coating layer that covers the operating flux to prevent the operating flux from flowing.

In the protective element, the coating layer may be a film formed by curing of a surface of the operating flux itself.

In the protective element, the coating layer may be made of a coating material that covers a surface of the operating flux, the coating material being different from the operating flux.

In the protective element, the coating material may be sheet-shaped.

In the protective element, the coating layer may be made of a thermosetting resin.

In the protective element, the coating layer may be made of an ultraviolet curable resin.

In the protective element, the coating layer may be made of an electron beam curable resin.

In the protective element, the coating layer may be made of an epoxy resin.

In the protective element, the coating layer may be made of an acrylic resin or an acrylic ester resin.

In the protective element, the operating flux may be partially provided on a surface of the fuse element.

A protective element according to another aspect of the present disclosure includes: an insulating substrate; a heat generation element provided on the insulating substrate; at least two main electrodes provided on the insulating substrate; a current-conducting electrode provided on the insulating substrate, for current conduction through the heat generation element; a fuse element provided on the at least two main electrodes and the current-conducting electrode; and an operating flux provided on the fuse element. The operating flux has, on a surface thereof, a coating layer that covers the operating flux to prevent the operating flux from flowing.

In the protective element, the coating layer may be made of a thermosetting resin.

In the protective element, the coating layer may be made of an ultraviolet curable resin.

In the protective element, the coating layer may be made of an electron beam curable resin.

In the protective element, the coating layer may be made of an epoxy resin.

In the protective element, the coating layer may be made of an acrylic resin or an acrylic ester resin.

In the protective element, the current-conducting electrode may be arranged between the at least two main electrodes with gap portions interposed, and the operating flux may be provided on a portion of the fuse element that overlaps with the current-conducting electrode, and a portion of the fuse element that overlaps with the gap portions extending from the current-conducting electrode to ends of the at least two main electrodes.

In the protective element, the fuse element may be made of a composite material of a first fusible metal and a second fusible metal.

In the protective element, the first fusible metal or the second fusible metal may be made of a tin-based alloy containing one or both of silver and copper.

In the protective element, at least one of the first fusible metal and the second fusible metal may be made of a lead-free tin-based solder material.

In the protective element, at least one of the first fusible metal and the second fusible metal may be an alloy material selected from an Sn—Ag alloy containing 3 to 4 mass % of Ag and a remainder of Sn, an Sn—Cu—Ag alloy containing 0.5 to 0.7 mass % of Cu, 0 to 1 mass % of Ag and a remainder of Sn, an Sn—Ag—Cu alloy containing 3 to 4 mass % of Ag, 0.5 to 1 mass % of Cu and a remainder of Sn, and an Sn—Bi alloy containing 10 to 60 mass % of Bi and a remainder of Sn.

In the protective element, at least one of the first fusible metal and the second fusible metal may be an alloy material selected from a 96.5Sn-3.5Ag alloy, a 99.25Sn-0.75Cu alloy, a 96.5Sn-3Ag-0.5Cu alloy, a 95.5Sn-4A5-0.5Cu alloy, and a 42Sn-58Bi alloy.

A protective element according to still another aspect of the present disclosure includes: an insulating substrate; a heat generation element provided on the insulating substrate; at least two main electrodes provided on the insulating substrate; a current-conducting electrode provided on the insulating substrate, for current conduction through the heat generation element; a fuse element provided on the at least two main electrodes and the current-conducting electrode; and an operating flux provided on the fuse element. The operating flux contains a curable resin component, and the operating flux has a coating layer that covers a surface of the operating flux, the coating layer being made of the curable resin component.

In the protective element, the coating layer may be composed of a film formed by curing of the surface of the operating flux.

In the protective element, the curable resin component may be made of an epoxy resin.

In the protective element, the current-conducting electrode may be arranged between the at least two main electrodes with gap portions interposed, and the operating flux may be provided on a portion of the fuse element that overlaps with the current-conducting electrode, and a portion of the fuse element that overlaps with the gap portions extending from the current-conducting electrode to ends of the at least two main electrodes.

In the protective element, the fuse element may be made of a composite material of a first fusible metal and a second fusible metal.

In the protective element, the first fusible metal or the second fusible metal may be made of a tin-based alloy containing one or both of silver and copper.

In the protective element, at least one of the first fusible metal and the second fusible metal may be made of a lead-free tin-based solder material.

In the protective element, at least one of the first fusible metal and the second fusible metal may be an alloy material selected from an Sn—Ag alloy containing 3 to 4 mass % of Ag and a remainder of Sn, an Sn—Cu—Ag alloy containing 0.5 to 0.7 mass % of Cu, 0 to 1 mass % of Ag and a remainder of Sn, an Sn—Ag—Cu alloy containing 3 to 4 mass % of Ag, 0.5 to 1 mass % of Cu and a remainder of Sn, and an Sn—Bi alloy containing 10 to 60 mass % of Bi and a remainder of Sn.

In the protective element, at least one of the first fusible metal and the second fusible metal may be an alloy material selected from a 96.5Sn-3.5Ag alloy, a 99.25Sn-0.75Cu alloy, a 96.5Sn-3Ag-0.5Cu alloy, a 95.5Sn-4Ag-0.5Cu alloy, and a 42Sn-58Bi alloy.

### Advantageous Effects of Invention

According to an embodiment of the present disclosure, there can be provided a protective element that prevents an operating flux applied to a surface of a fuse element from flowing from the surface of the fuse element even when the protective element is exposed to severe thermal environment.

### BRIEF DESCRIPTION OF DRAWINGS

FIG. 1 shows a protective element according to an embodiment of the present disclosure, and (a) is a plan view showing a state in which a cap-shaped lid is cut along Ia-Ia line in (b), (b) is a cross-sectional view showing a state in which the protective element is cut along Ib-Ib line in (a), and (c) is a bottom view showing the protective element.

FIG. 2 shows a protective element according to an embodiment of the present disclosure, and (a) is a plan view showing a state in which a cap-shaped lid is cut along IIa-IIa line in (b), (b) is a cross-sectional view showing a state in which the protective element is cut along IIb-IIb line in (a), and (c) is a bottom view of the protective element.

FIG. 3 shows a modification of the protective element shown in FIG. 1, and (a) is a plan view showing a state in which a cap-shaped lid is cut along IIIa-IIIa line in (b), (b) is a cross-sectional view showing a state in which the protective element is cut along IIIb-IIIb line in (a), and (c) is a bottom view of the protective element.

FIG. 4 shows a modification of the protective element shown in FIG. 2, and (a) is a plan view showing a state in which a cap-shaped lid is cut along IVa-IVa line in (b), (b) is a cross-sectional view showing a state in which the protective element is cut along IVb-IVb line in (a), and (c) is a bottom view of the protective element.

### DESCRIPTION OF EMBODIMENTS

A protective element according to the present disclosure includes: at least two electrode portions supported by an insulating support; a fuse element that connects the electrode portions; and an operating flux provided on the fuse element. The operating flux has a coating layer that covers the operating flux to prevent the operating flux from flowing.

Any coating layer may be used as the coating layer as long as it can cover an entire surface of the operating flux. The coating layer may be a film formed by curing of the surface of the operating flux itself. The coating layer may be a coating material different from the operating flux that covers the surface of the operating flux after the operating flux is applied.

The coating layer may be formed by applying a liquid coating material onto the operating flux and then forming a film. The coating layer may be formed by putting a flexible and easily-deformable solid-sheet-shaped coating material or a flexible and easily-deformable semi-solid (such as semi-polymerized resin)-sheet-shaped coating material on the operating flux. The sheet-shaped coating material is adsorbed or compression-bonded to the surface of the operating flux. At the time of adsorption or compression bonding, the sheet-shaped coating material may be heated. The coating material may be a thermosetting resin unless it exhibits fluidity at a desired temperature.

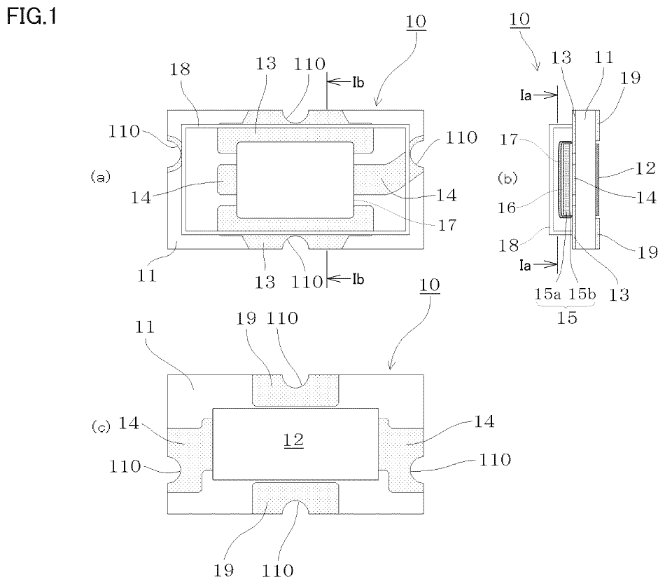

As one example of the protective element, a protective element 10 shown in FIG. 1 includes an insulating substrate 11, a heat generation element 12 provided on insulating substrate 11, at least two main electrodes 13 provided on insulating substrate 11, a current-conducting electrode 14 provided on insulating substrate 11, for current conduction through heat generation element 12, a fuse element 15 provided on at least two main electrodes 13 and current-conducting electrode 14, and an operating flux 16 provided on fuse element 15. Fuse element 15 is made of a composite material of a first fusible metal 15a and a second fusible metal 15b. Operating flux 16 has, on a surface thereof, a coating layer 17 that covers operating flux 16 to prevent operating flux 16 from flowing.

Insulating substrate 11 forms an insulating support that supports main electrodes 13 (electrode portions). The insulating support is not limited to the insulating substrate.

Operating flux 16 does not necessarily need to be applied to an entire exposed surface of fuse element 15. Operating flux 16 may be partially applied to a portion of the surface of fuse element 15 required for operation.

Coating layer 17 extends on a surface of operating flux 16 and on a part of fuse element 15 beyond an end surface where operating flux 16 is applied. Any alloy may be used as first fusible metal 15a and second fusible metal 15b as long as it is a fusible metal that can melt as a result of heating by heat generation element 12. Although the alloy is not particularly limited, an Sn—Ag alloy containing 3 to 4 mass % of Ag and a remainder of Sn, an Sn—Cu—Ag alloy containing 0.5 to 0.7 mass % of Cu, 0 to 1 mass % of Ag and a remainder of Sn (here, silver is not essential and is added as needed), an Sn—Ag—Cu alloy containing 3 to 4 mass % of Ag, 0.5 to 1 mass % of Cu and a remainder of Sn, and an Sn—Bi alloy containing 10 to 60 mass % of Bi and a remainder of Sn can be used as a first example. A tin-based solder material such as a 96.5Sn-3.5Ag alloy, a 99.25Sn-0.75Cu alloy, a 96.5Sn-3Ag-0.5Cu alloy, a 95.5Sn-4Ag-0.5Cu alloy, or a 42Sn-58Bi alloy can be used as a second example of the alloy (the coefficients of each alloy material represent mass % of the elements).

Instead of the above-described fusible metal, a metal material that is dissolved into first fusible metal 15a as a result of heating by heat generation element 12 may be used as second fusible metal 15b. Although the metal material is not particularly limited, silver, copper, or an alloy containing these can be suitably used as one example. For example, a lead-free tin-based solder material such as an Sn—Ag alloy containing 25 to 40 mass % of Ag and a remainder of Sn can be used as a silver alloy.

In protective element 10, film-like coating layer 17 encloses an outer layer portion of operating flux 16 and covers an end of fuse element 15. Thus, operating flux 16 liquefied by heat during fusing can be held within coating layer 17 to prevent operating flux 16 from flowing from the applied surface of fuse element 15 until fuse element 15 melts.

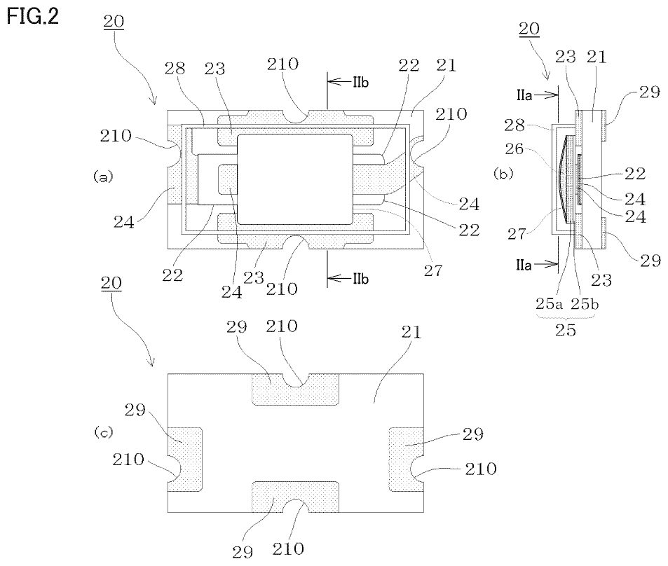

As another example of the protective element, a protective element 20 shown in FIG. 2 includes an insulating substrate 21, a heat generation element 22 provided on insulating substrate 21, at least two main electrodes 23 provided on insulating substrate 21, a current-conducting electrode 24 provided on insulating substrate 21, for current conduction through heat generation element 22, a fuse element 25 provided on at least two main electrodes 23 and current-conducting electrode 24, and an operating flux 26 provided on fuse element 25. Fuse element 25 is made of a composite material of a first fusible metal 25a and a second fusible metal 25b. Operating flux 26 contains a curable resin component. After operating flux 26 is applied to fuse element 25, a surface of operating flux 26 is cured to generate a coating layer 27 that covers operating flux 26 to prevent operating flux 26 from flowing. Protective element 20 includes coating layer 27 made of a curable resin component and provided to cover the surface of operating flux 26.

Operating flux 26 does not necessarily need to be applied to an entire exposed surface of fuse element 25. Operating flux 26 may be partially applied to at least a portion of the surface of fuse element 25 required for operation.

Coating layer 27 is a film formed by curing of the surface of operating flux 26. Any alloy may be used as first fusible metal 25a and second fusible metal 25b as long as it is a fusible metal that can melt as a result of heating by heat generation element 22. Although the alloy is not particularly limited, an Sn—Ag alloy containing 3 to 4 mass % of Ag and a remainder of Sn, an Sn—Cu—Ag alloy containing 0.5 to 0.7 mass % of Cu, 0 to 1 mass % of Ag and a remainder of Sn (here, silver is not essential and is added as needed), an Sn—Ag—Cu alloy containing 3 to 4 mass % of Ag, 0.5 to 1 mass % of Cu and a remainder of Sn, and an Sn—Bi alloy containing 10 to 60 mass % of Bi and a remainder of Sn can be used as a first example. A tin-based solder material such as a 96.5Sn-3.5Ag alloy, a 99.25Sn-0.75Cu alloy, a 96.5Sn-3Ag-0.5Cu alloy, a 95.5Sn-4Ag-0.5Cu alloy, or a 42Sn-58Bi alloy can be used as a second example of the alloy (the coefficients of each alloy material represent mass % of the elements).

Instead of the above-described fusible metal, a metal material that is dissolved into first fusible metal 25a as a result of heating by heat generation element 22 may be used as second fusible metal 25b. Although the metal material is not particularly limited, silver, copper, or an alloy containing these can be suitably used as one example. For example, a lead-free tin-based solder material such as an Sn—Ag alloy containing 25 to 40 mass % of Ag and a remainder of Sn can be used as a silver alloy.

In protective element 20, the curable resin component, which is an additive contained in operating flux 26, is cured on the surface to generate film-like coating layer 27. Coating layer 27 encloses an outer layer portion of operating flux 26 and is fixed to a perimeter end of fuse element 25. Thus, operating flux 26 liquefied by heat during fusing can be held within coating layer 27 to prevent operating flux 26 from flowing from the applied surface of fuse element 25 until fuse element 25 melts.

### Examples

As shown in FIG. 1, protective element 10 in Example 1 according to the present disclosure includes insulating substrate 11 made of alumina. Protective element 10 includes heat generation element 12 composed of a thick film resistor on a lower surface of insulating substrate 11. Protective element 10 includes two main electrodes 13 made of sintered silver and provided on an upper surface of insulating substrate 11, and current-conducting electrode 14 made of sintered silver and provided on the upper surface of insulating substrate 11 for use in current conduction through heat generation element 12.

Protective element 10 includes fuse element 15 provided on main electrodes 13 and current-conducting electrode 14 and made of a composite material of first fusible metal 15a and second fusible metal 15b, first fusible metal 15a being made of a 96.5Sn-3Ag-0.5Cu alloy, second fusible metal 15b being made of silver. Protective element includes operating flux 16 applied to fuse element 15. Operating flux 16 has, on a surface thereof, coating layer 17 made of an epoxy resin and provided to cover operating flux 16 to prevent operating flux 16 from flowing.

Protective element 10 includes a cap-shaped lid 18 made of liquid crystal polymer and fixed to insulating substrate 11 to cover fuse element 15 and operating flux 16. A protective insulating film made of glass glaze is provided on a surface of heat generation element 12. Protective element 10 includes wiring means 110 formed of a half through hole made of sintered silver. Wiring means 110 is for electrically connecting main electrodes 13 and current-conducting electrode 14 that are provided on the upper surface of insulating substrate 11 to pattern electrodes 19 and current-conducting electrode 14 that are provided on the lower surface of insulating substrate 11. Instead of the thermosetting epoxy resin, coating layer 17 can be made of an ultraviolet (UV) curable resin such as an acrylic acid-based resin or an acrylic ester-based resin, or an electron beam (EB) curable resin.

As shown in FIG. 2, protective element 20 in Example 2 according to the present disclosure includes insulating substrate 21 made of alumina. Protective element 20 includes heat generation element 22 composed of a thick film resistor and provided on an upper surface of insulating substrate 21. Protective element 20 includes two main electrodes 23 made of sintered silver and provided on the upper surface of insulating substrate 21, and current-conducting electrode 24 made of sintered silver and provided on the upper surface of insulating substrate 21 for use in current conduction through heat generation element 22.

Protective element 20 includes fuse element 25 provided on main electrodes 23 and current-conducting electrode 24 and made of a composite material of first fusible metal 25a and second fusible metal 25b, first fusible metal 25a being made of a 96.5Sn-3Ag-0.5Cu alloy, second fusible metal 25b being made of a 70Sn-30Ag alloy. Operating flux 26 contains an epoxy resin component as a blended component, and has coating layer 27 made of an epoxy resin component and provided to cover the surface of operating flux 26.

Protective element 20 includes a cap-shaped lid 28 made of liquid crystal polymer and fixed to insulating substrate 21 to cover fuse element 25 and operating flux 26 including coating layer 27. Glass glaze (protective insulating film) is provided on a surface of heat generation element 22. Main electrodes 23 and current-conducting electrode 24 provided on the upper surface of insulating substrate 21 include wiring means 210 formed of a half through hole made of sintered silver for electrical connection to a pattern electrode 29 provided on the lower surface of insulating substrate 21. Heat generation element 22 of the protective element in Example 2 is provided on the same surface (upper surface) as the surface (upper surface) of insulating substrate 21 where fuse element 25 is provided.

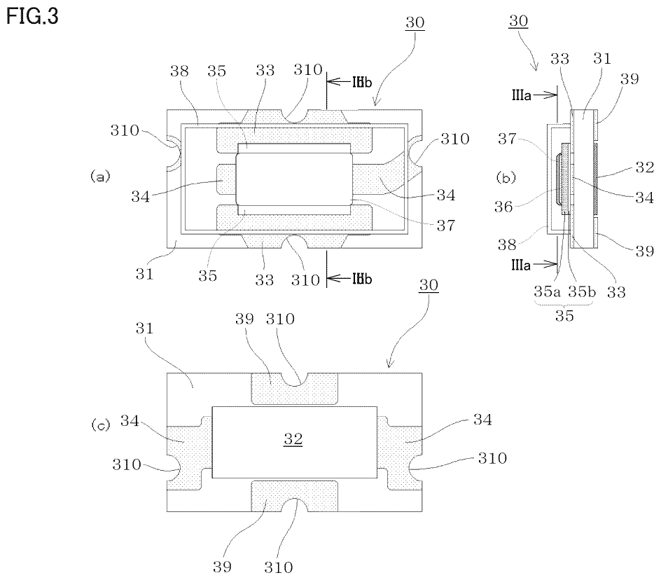

The portion of protective element 10 in Example 1 to which operating flux 16 is applied may be changed and an operating flux 36 may be applied as shown in FIG. 3. In a protective element 30, a current-conducting electrode 34 is arranged between two main electrodes 33 with gap portions interposed. In other words, there is a gap portion between one main electrode 33 and current-conducting electrode 34, and there is also a gap portion between the other main electrode 33 and current-conducting electrode 34. Operating flux 36 of protective element 30 is applied onto a portion of a fuse element 35 that overlaps with current-conducting electrode 34, and portions that overlap with the gap portions extending from current-conducting electrode 34 to ends of main electrodes 33. The remaining configuration of protective element 30 except for the above-described portions to which operating flux 36 is applied is in common with the configuration of protective element 10 in Example 1, and thus, the common components are given the corresponding reference numerals and description thereof will not be repeated.

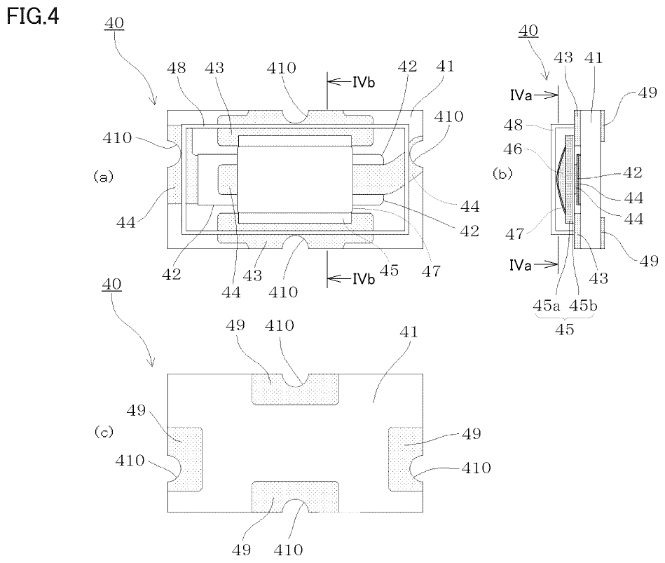

The portion of protective element 20 in Example 2 to which operating flux 26 is applied may be changed and an operating flux 46 may be applied as shown in FIG. 4. In a protective element 40, a current-conducting electrode 44 is arranged between two main electrodes 43 with gap portions interposed. In other words, there is a gap portion between one main electrode 43 and current-conducting electrode 44, and there is also a gap portion between the other main electrode 43 and current-conducting electrode 44. Operating flux 46 of protective element 40 is applied onto a portion of a fuse element 45 that overlaps with current-conducting electrode 44, and a portion of fuse element 45 that overlaps with the gap portion extending from current-conducting electrode 44 to an end of each of main electrodes 43. The remaining configuration of protective element 40 except for the above-described portion to which operating flux 46 is applied is the same as the configuration of protective element 20 in Example 2, and thus, the same components are given the corresponding reference numerals and description thereof will not be repeated.

In the protective element in each of Example 1 and Example 2, the wiring means that electrically connects the main electrodes and the current-conducting electrode to the pattern electrode, which are separated by the insulating substrate, may be a conductor through hole passing through the insulating substrate, or may be a surface wiring formed by a planar electrode pattern, instead of the half through hole. Instead of silver or copper, a tin-based alloy containing at least one or both of silver and copper can be used as the second low-melting-point metal material.

Although the embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

### INDUSTRIAL APPLICABILITY

The protective element according to the present disclosure can be mounted on another circuit board by, for example, reflow soldering and can be used in a protection device for a secondary battery, such as a battery pack.

### REFERENCE SIGNS LIST

10, 20, 30, 40 protective element
11, 21, 31, 41 insulating substrate
12, 22, 32, 42 heat generation element
13, 23, 33, 43 main electrode
14, 24, 34, 44 current-conducting electrode
25, 35, 45, 200 fuse element
15a, 25a, 35a, 45a first fusible metal
25b, 35b, 45b second fusible metal
16, 26, 36, 46 operating flux
17, 27, 37, 47 coating layer
18, 28, 38, 48 cap-shaped lid
19, 29, 39, 49 pattern electrode
110, 210, 310, 410 wiring means

What is claimed is:

1. A protective element comprising:
at least two electrode portions supported by an insulating support;
a fuse element that connects the electrode portions; and
an operating flux provided on the fuse element; wherein
the operating flux has, on a surface thereof, a coating layer that covers the operating flux to prevent the operating flux from flowing; and
the coating layer is a film formed by curing of a surface of the operating flux itself.

2. The protective element according to claim 1, wherein the operating flux is partially provided on a surface of the fuse element.

3. The protective element according to claim 1, wherein
the current-conducting electrode is arranged between the at least two main electrodes with gap portions interposed; and
the operating flux is provided on a portion of the fuse element that overlaps with the current-conducting electrode, and a portion of the fuse element that overlaps with the gap portions extending from the current-conducting electrode to ends of the at least two main electrodes.

4. A protective element comprising:
an insulating substrate;
a heat generation element provided on the insulating substrate;
at least two main electrodes provided on the insulating substrate;
a current-conducting electrode provided on the insulating substrate for current conduction through the heat generation element;
a fuse element provided on the at least two main electrodes and the current-conducting electrode; and
an operating flux provided on the fuse element; wherein
the operating flux contains a curable resin component; and
the operating flux has a coating layer that covers a surface of the operating flux, the coating layer being made of the curable resin component.

5. The protective element according to claim 4, wherein the coating layer is composed of a film formed by curing of the surface of the operating flux.

6. The protective element according to claim 4, wherein the curable resin component is made of an epoxy resin.

7. The protective element according to claim 4, wherein
the current-conducting electrode is arranged between the at least two main electrodes with gap portions interposed; and
the operating flux is provided on a portion of the fuse element that overlaps with the current-conducting electrode, and a portion of the fuse element that overlaps with the gap portions extending from the current-conducting electrode to ends of the at least two main electrodes.

8. The protective element according to claim 4, wherein the fuse element is a composite material of a first fusible metal and a second fusible metal.

9. The protective element according to claim 8, wherein the first fusible metal or the second fusible metal is a tin-based alloy containing one or both of silver and copper.

10. The protective element according to claim 8, wherein at least one of the first fusible metal and the second fusible metal is a lead-free tin-based solder material.

11. The protective element according to claim 8, wherein at least one of the first fusible metal and the second fusible metal is an alloy material selected from an Sn—Ag alloy containing 3 to 4 mass % of Ag and a remainder of Sn, an Sn—Cu—Ag alloy containing 0.5 to 0.7 mass % of Cu, 0 to 1 mass % of Ag and a remainder of Sn, an Sn—Ag—Cu alloy containing 3 to 4 mass % of Ag, 0.5 to 1 mass % of Cu and a remainder of Sn, and an Sn—Bi alloy containing 10 to 60 mass % of Bi and a remainder of Sn.

12. The protective element according to claim 8, wherein at least one of the first fusible metal and the second fusible metal is an alloy material selected from a 96.5Sn-3.5Ag alloy, a 99.25Sn-0.75Cu alloy, a 96.5Sn-3Ag-0.5Cu alloy, a 95.5Sn-4Ag-0.5Cu alloy, and a 42Sn-58Bi alloy.
